(19) United States
(12) Patent Application Publication
(10) Pub. No.: US 2016/0092407 A1
(43) Pub. Date: Mar. 31, 2016

(54) DOCUMENT PROCESSING USING MULTIPLE PROCESSING THREADS

(71) Applicant: ABBYY Development LLC, Moscow (RU)

(72) Inventor: Vitaly Ball, Moscow (RU)

(21) Appl. No.: 14/570,056

(22) Filed: Dec. 15, 2014

(30) Foreign Application Priority Data
Sep. 30, 2014 (RU) 2014139558

(51) Int. Cl. G06F 17/21; G06T 1/20

(52) U.S. Cl. CPC G06F 17/212; G06T 1/20

(57) ABSTRACT

Systems and methods for assembling parts of a multi-part document. An example method comprises: assigning a plurality of image processing tasks to a plurality of worker processes; defining input parameters for each task of the plurality of tasks, the input parameters comprising a part of an original document and a structure definition of the part, the structure definition including a reference to a element requiring time-consuming processing (e.g., graphical element) comprised by the part of the original document; and outputting, into a file representing the original document, a plurality of images produced by the plurality of worker processes based on elements requiring time-consuming processing (e.g., graphical elements) defined by the input parameters.

### CROSS REFERENCE TO RELATED APPLICATIONS

This application claims the benefit of priority to Russian patent application no. 2014139558, filed Sep. 30, 2014; disclosure of which is incorporated herein by reference in its entirety.

### TECHNICAL FIELD

The present disclosure is generally related to computing devices for processing electronic documents and more specifically for processing documents using parallel processing.

### BACKGROUND

A paper document can be converted to an electronic file by digitizing (e.g., scanning) each page of the paper document to produce a series of images. The images are then processed to create a single document, for example, a Portable Document Format (PDF) or a Tagged Image File Format (TIFF). The process of converting the series of images is often computationally intensive and requires a substantial amount of time.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a block diagram of one embodiment of a computing device operating in accordance with one or more aspects of the present disclosure;

FIG. 2 illustrates an example of a multi-part file that may be processed in accordance with one or more aspects of the present disclosure;

FIG. 3 illustrates an example of a multi-part file being processed by a main process and multiple worker processes in accordance with one or more aspects of the present disclosure;

FIG. 4 depicts a flow diagram of one illustrative example of a method 400 for processing a file by utilizing parallel processing, in accordance with one or more aspects of the present disclosure;

FIG. 4A depicts a flow diagram that expands block 440 of FIG. 4, in accordance with one or more aspects of the present disclosure.

FIG. 5 depicts a more detailed diagram of an illustrative example of a computing device implementing the methods described herein.

### DETAILED DESCRIPTION

The present disclosure relates to a method of utilizing parallel processing in producing a document (e.g., PDF, DjVu, TIFF, PNG, JPEG, EPS or other bucket-type document). The method may involve using multiple processes that function together to process graphical and/or textual elements and assemble it into a file. Process herein refers to a single stream executing a sequence of instructions and may be provided by, for example, a Unix process, or Linux thread. In one example, there may be a main process and multiple worker processes that function together to assemble one or more documents into a single PDF file.

The main process may analyze an original document and direct worker processes to perform processing on portions of the original document. The analysis may include identifying parts of the document that include one or more elements requiring time-consuming processing, for example, graphical elements (e.g., photos, line drawings, pictures), audios and the like, at which point the main process may employ a worker process to process the document part. An element, requiring time-consuming processing, is a part of a document, whose processing utilizes substantially more time than other parts of the document. To illustrate the present invention, graphical elements will hereinafter be considered as elements requiring time-consuming processing. In one example, each part may be an image of a page of a multipage document. If multiple parts include graphics, the main process may employ a separate worker process for each part. The main process may execute asynchronously with respect to the worker processes and may continue to process other parts of the document while the worker processes execute. Once the main process has completed a portion of its processing, it may wait until all of the worker processes have finished before continuing with the final assembly of the file.

The main processor may create the worker processes by spawning child processes using, for example, Unix fork( ), Linux pthread_create( ) or another similar system call. The quantity of worker processes may depend on the number of tasks identified by the main processor yet may be restricted based on the total number of available processing units (e.g., cores). Each task may involve processing a single part of the document (e.g., page). A task may be created, for example, for each and every page, irrespectively of the location of graphical elements or alternatively, for only pages containing graphical elements. The main process may queue the tasks when the number of tasks is greater than the number of worker processes.

In one example, the main process may analyze an internal representation of a document and determine it has 40 pages. Of the 40 pages, there may be 10 pages that include graphics. Therefore, the main process may employ 10 tasks corresponding to each of the 10 pages. If there are only 8 processor cores the main process may generate up to 7 worker processes and the remaining three tasks may be queued and processed by a worker process after completing its current task.

The technology disclosed herein may provide several advantages, for example, decreasing the time required to assemble a document file. This may occur because processing graphical elements (e.g., compression, resolution/image format/chromaticity/quality change, image noise reduction) is often significantly more computationally complex then processing text (e.g., font modifying). By having worker processes process the graphics in parallel, the overall time needed to assemble the document may be decreased.

Various aspects of the above referenced methods and systems are described in details herein below by way of examples, rather than by way of limitation.

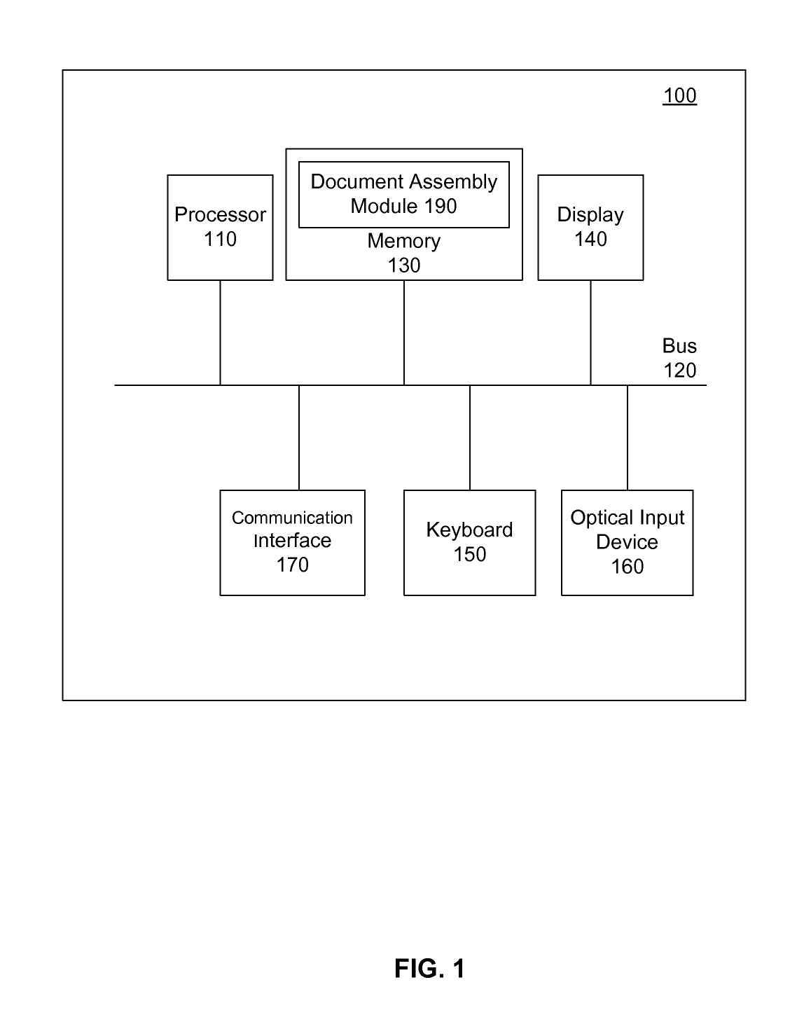

FIG. 1 depicts a block diagram of one illustrative example of a computing device 100 operating in accordance with one or more aspects of the present disclosure. In illustrative examples, computing device 100 may be provided by various computing devices including a tablet computer, a smart phone, a notebook computer, or a desktop computer.

Computing device 100 may comprise a processor 110 coupled to a system bus 120. Other devices coupled to system bus 120 may include a memory 130, a display 140, a keyboard 150, an optical input device 160 and one or more communication interfaces 170. The term “coupled” herein shall refer to being electrically connected and/or communicatively coupled via one or more interface devices, adapters and the like.

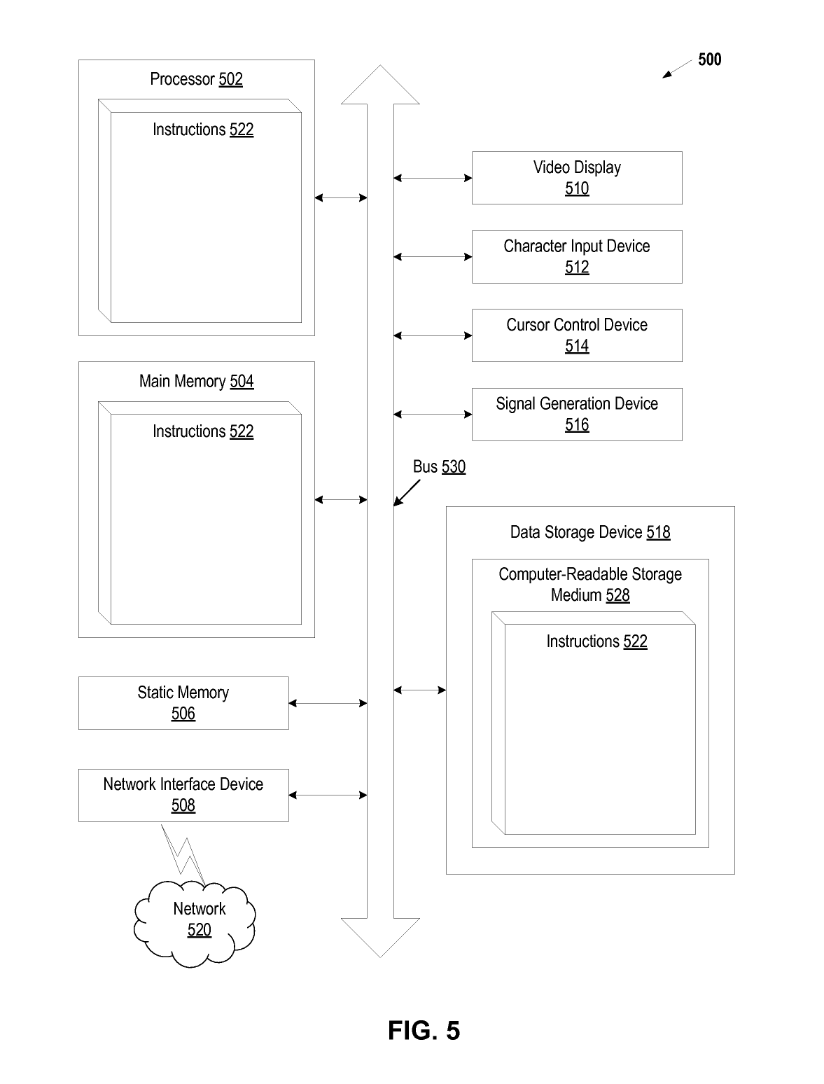

In various illustrative examples, processor 110 may comprise one or more processing units. A processing unit may be a portion of hardware that performs a stream of execution independently of other streams of execution within the same processor. The processing unit may be a processor core included within a central processor unit (CPU), digital signal processors (DSP), graphics processor units (GPU) or any other similar type of hardware processor. The processing units may be from a single hardware source (e.g., server) or a group of hardware sources (e.g., cluster, server farm) that may be logically combined and capable of functioning as a single resource (e.g., cloud). Memory 130 may comprise one or more volatile memory devices (for example, RAM chips), one or more non-volatile memory devices (for example, ROM or EEPROM chips), and/or one or more storage memory devices (for example, optical or magnetic disks). Optical input device 160 may be provided by a scanner or a still image camera configured to acquire the light reflected by the objects situated within its field of view. The input information may be any electronic document that has undergone image processing, document analysis and OCR steps. An example of a computing device implementing aspects of the present disclosure will be discussed in more detail below with reference to FIG. 5.

Memory 130 may store instructions of module 190 for generating electronic documents in a pre-defined format. In certain implementations, module 190 may perform methods of assembling a document with graphics, in accordance with one or more aspects of the present disclosure. In an illustrative example, module 190 may be implemented as a function to be invoked via a user interface of an application. Alternatively, module 190 may be implemented as a standalone application.

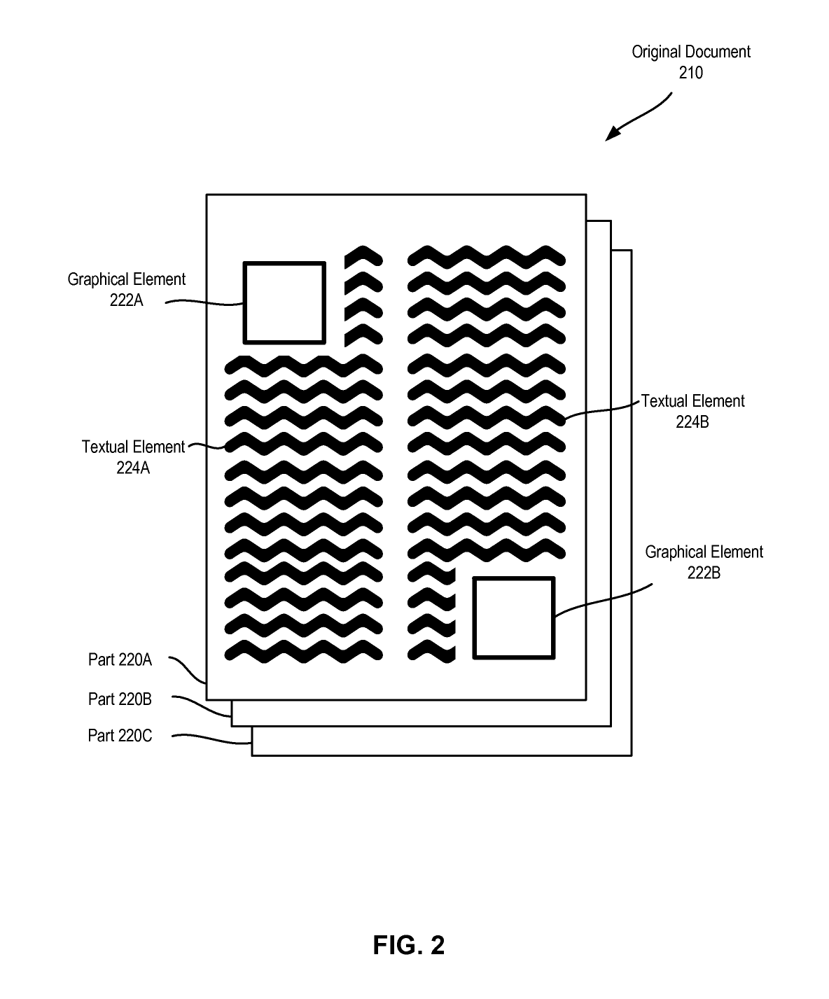

FIG. 2 illustrates an example of a multi-part document 210 that may be processed by module 190 running on computing device 100 in accordance with one or more aspects of the present disclosure. The document 210 may include parts 220A-C (e.g., pages), which may include graphical elements 222A-B and textual elements 224A-B. These elements have been selected for illustrative purposes only and are not intended to limit the scope of this disclosure in any way.

Document 210 may include one or more digital elements that may be visually rendered to provide a visual representation of the electronic document (e.g., on a display or a printed material). Document 210 may be an internal representation stored by module 190 having a structure that allows for fast access. As shown in FIG. 2 the document 210 may be a scanned magazine that may have undergone image processing, document analysis and OCR steps. In one example, document 210 may be in a format that may not be read by any module, other than module 190. The present invention describes a method to save the document from its internal representation to any output format, which may be read by an independent module or software application.

The internal presentation of document 210 may include reference information that identifies a location of graphical elements 222A-B and/or textual elements 224A-B. Document 210 may also include other elements (e.g., page layout or logical structure of pages), which are not shown in FIG. 2. In one example, document 210 may include a presentation, a spreadsheet and/or an album in which case its component parts 220A-C may be pages, slides, cells, and pictures respectively.

Textual elements 224A-B may be in any color, font or arrangement, such as blocks, columns, tables or other similar arrangement. The graphical elements 222A-B may include, for example, a photograph, picture, illustration, drawing, diagram, graph, chart, symbol, or other similar graphic.

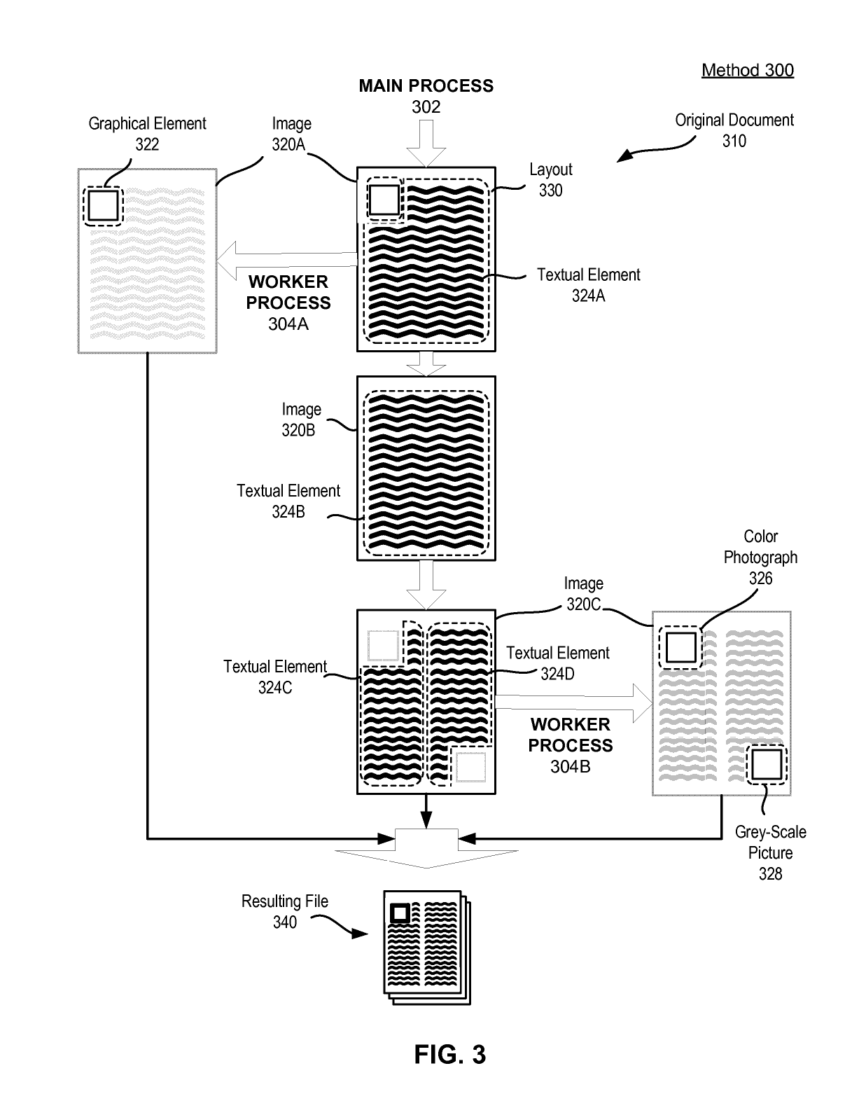

FIG. 3 illustrates an example method 300, wherein computing device 100 may utilize multiple processes to process document 310 and its multiple parts (e.g., images 320A-C) into resulting file 340. Each of the images 320A-C may represent a page of an electronic document and may include graphical elements 322, 326, 328 and textual elements 324A-D. Images 320A-C may be produced by scanning or otherwise acquiring an image or series of images from a paper document and further image processing, document analysis and OCR processes. In various illustrative examples, the resulting file 340 may be in a file format that is independent of application software, hardware and operating systems and may encapsulate a complete description of a fixed-layout flat document including the text, fonts, graphics, and other information needed to display it, for example, similar to PDF or DjVu file.

Images 320A-C may be processed by main process 302 and/or worker processes 304A-B. Processing an image may include transforming the image, or a portion of the image into a desired format. The transformation may include, for example, compression, change of resolution, formatting, modification of chromaticity, noise reduction and/or image segmentation. The compression may include executing one or more compression technologies (e.g., algorithms) that accommodate images that contain both binary text and continuous-tone components, for example similar to Mixed Raster Content (MRC).

The selection of an optimum compression algorithm may depend on the graphical element type (e.g., photo, line drawing, cartoon) or the intended document size. In one example, the compression algorithm selected may be lossless, which may reduce the size of the image data with minimal loss in image quality. This may include identifying and eliminating statistical redundancies, similar to PNG or GIF. In another example, the compression algorithm may be a lossy compression, which may reduce the size of the image but may do so by reducing image quality, for example, by identifying unnecessary information and removing it, similar to JPEG.

As shown in FIG. 3, document 310 may be processed by both main process 302 and worker processes 304A-B. The method may begin with main process 302 analyzing the images (e.g., pages) of a document part to identify graphical elements 322, 326 and 328 and textual elements 324A-D. Analyzing the layout may involve accessing a data structure that includes location reference information (e.g., coordinates) of elements in the layout. Based on the layout, main process 302 may determine that all the images (e.g., 320A-C) include textual elements and some images (e.g., 320A and 320C) also include graphical elements. For the images of document parts that include a graphical element the main process 302 may generate a worker process to process the graphical element and the remaining portions of the images (e.g., text portions) may be processed by main process 302.

In some implementations, the presence of graphical elements is not considered, because the image of the whole page is required to be processed (e.g., when saving to PDF text under/over the page image format file). Then worker processes for processing the image of each page of the document are generated.

Main process 302 may employ multiple worker processes 304A-B and may provide the worker processes 304A-B with information (e.g., input parameters) to identify the respective image and graphical element locations. The location information may be in the form of a structure definition, which may include a location (e.g., coordinates) and dimensions of the portion of an image that includes graphic content.

Each worker process may process the image by compressing and formatting it and subsequently returning the results to main process 302. As shown in FIG. 3, main process 302 generates worker process 304A to process graphical element 322A of image 320A and spawns worker process 304B to process graphical elements 326 and 328 of image 320C. In one example, worker process 304A may process a part of the document (e.g., page) by processing graphical element 322 without processing the rest image 320A (e.g., textual element 324A) and in another example the worker process may process the entire image 320A including graphical element and textual elements. When an image has no graphical elements, as seen in image 320B, the main process 302 may process the image without using an additional worker process.

Each worker process 304A-B may be a child process of the main process or may be a thread within main process 302. As such, the main process may generate a worker process by creating a new child process using, for example, spawning, forking or other similar functionality. Alternatively, generating a worker process may include creating a new thread using the appropriate functionality. In another example, the main process may re-use an existing thread or child process.

Main process 302 may be asynchronous with respect to worker processes 304A-B, such that it may generate worker process 304A and may continue to process the document while worker processes 304A-B perform their respective processing. This allows module 190 to process the multiple parts of document 310 in parallel (e.g., parallel processing). In one example, the system may support a dual-level parallelism, wherein the main process may spawn one or more child processes (e.g., first level of parallelism) and each child process may have multiple threads (i.e., second level of parallelism). This may allow, for example, the main process to spawn a child process to handle a page with multiple graphics and the child process may have multiple threads each processing one of the graphical elements on the page.

The quantity of worker processes may depend on a variety of conditions such as the quantity of tasks and/or the quantity of processing units. In one example, a task may be created for each image (e.g., page) that includes at least one graphical element. Therefore a hypothetical document having three pages, wherein two of the pages include two graphics each may result in the creation of two tasks. In another example, a task may be created for each graphical element, and thus in this example four tasks would be generated.

Main process 302 may create a worker process for each task until the quantity of worker processes hits a threshold number of worker processes. The threshold number of worker processes may be based on the system resources, for example, the threshold may be the quantity of processing units minus one to account for the main process. This allows the total number of processes (main and worked) to be less than or equal to the number of processing units.

As discussed above, processing units may correspond to the available cores and thus if a machine has two processors with four cores each, then there may be eight processing units and thus the threshold number of worker processes may be seven. If virtual machines are involved the processor units may be virtual or simulated processors, in which case the quantity of processing units would be based on the quantity of units available to the guest machine for use by application 190. In another example, the threshold may be based on quantity of memory used or not used (e.g., available) by the main process and/or system. If the system is low on memory it may reduce the threshold and thus consolidate the tasks amongst fewer worker processes. In one example, it may modify the threshold based on the average memory consumption of all or a portion of the worker processes.

When the quantity of worker processes hits the threshold, the main process may queue subsequent tasks. Queuing the tasks may involve storing the tasks in a data structure, such as a queue, list, array, and/or stack that supports a first in first out (FIFO). After a task is queued, the main process may distribute the queued tasks to a worker process that has completed or is about to complete its current task. In one example, the main processor may distribute the tasks to a worker process that has already processing an image and it may process the tasks serially or in parallel. In another example, the main process may distribute the tasks based on the order of priority, wherein larger tasks may have a higher priority. The main process may then direct a worker process to handle the higher priority task first or may break up the task into multiple tasks to be distributed to more than one worker processes.

When a worker process completes a task it may either terminate or enter a standby mode. Termination may occur automatically when the worker process returns the processed image or may be initiated by the main process. Alternatively, the worker process may complete a task and wait for another task. It may do so by entering a standby mode or sleep mode until the main thread directs it to process another task. In this situation, the worker process may not terminate until there are no more remaining tasks or until all of the images have been processed.

A single image (e.g., image 320C) may include multiple graphical elements, which may be processed using different encoding algorithms. The worker processes or main process may determine the type of a graphical element by accessing reference information (e.g., structure definition), that includes a graphical type field. Based on the graphical type, the working process or main process may select an encoding algorithm to be executed by the worker processes 304A-B or main process 302. As shown in FIG. 3, image 320C may include an embedded color photograph 326 and an embedded grey-scale picture 328. For the embedded color photograph 326, worker process 304B may analyze the graphic type and may select a compression algorithm that support photo realistic images (e.g., JPEG). For grey-scale picture 328, the same worker process 304B may select a compression algorithm that is better suited for grey-scale graphics. In another example, an image containing multiple graphical elements may be compressed using different algorithms (e.g., Mixed Raster Content (MRC) and the worker process processing this task may be divided into several independent worker processes. For example, if color photograph 326 and grey-scale picture 328 are needed to be compressed differently, the worker process 304B may be divided into two worker processes: one independent worker process (304C—not shown) processing photograph 326 and the other independent worker process (304D—not shown) processing picture 328.

Once all of the images have been processed, the main process 302 may assemble the resulting images into one or more resulting files 340. Assembling may include, for example, appending the images together (e.g., concatenating, stitching, joining) and other image processing steps discussed elsewhere. In one example, the images may have been processed out of order and thus the assembling step may also reorganize the processed images and alter the format (e.g., cropping, rotating) of one or more elements to optimize or enhance their presentation, for example, to make text and/or graphics clearer. In another example, the resulting document may be modified to replace text of the document with an identical or substantially similar standard font, which may further increase compression as well as reduce subsequent decompression time.

The original document 310 and/or resulting file 340 may include multiple layers. The multiple layers may include data superimposed on the original document, such as, textual metadata, comments, annotations or other similar data. An example of multi-layered document is a searchable pdf, which may have transparent layer of text superimposed over the textual elements of the document.

Main process 302 or worker processes 304A-B may modify the multi-layer document to consolidate all the layers down to one plane, for example, by flattening the image or document. This may remove or reduce the number of layers.

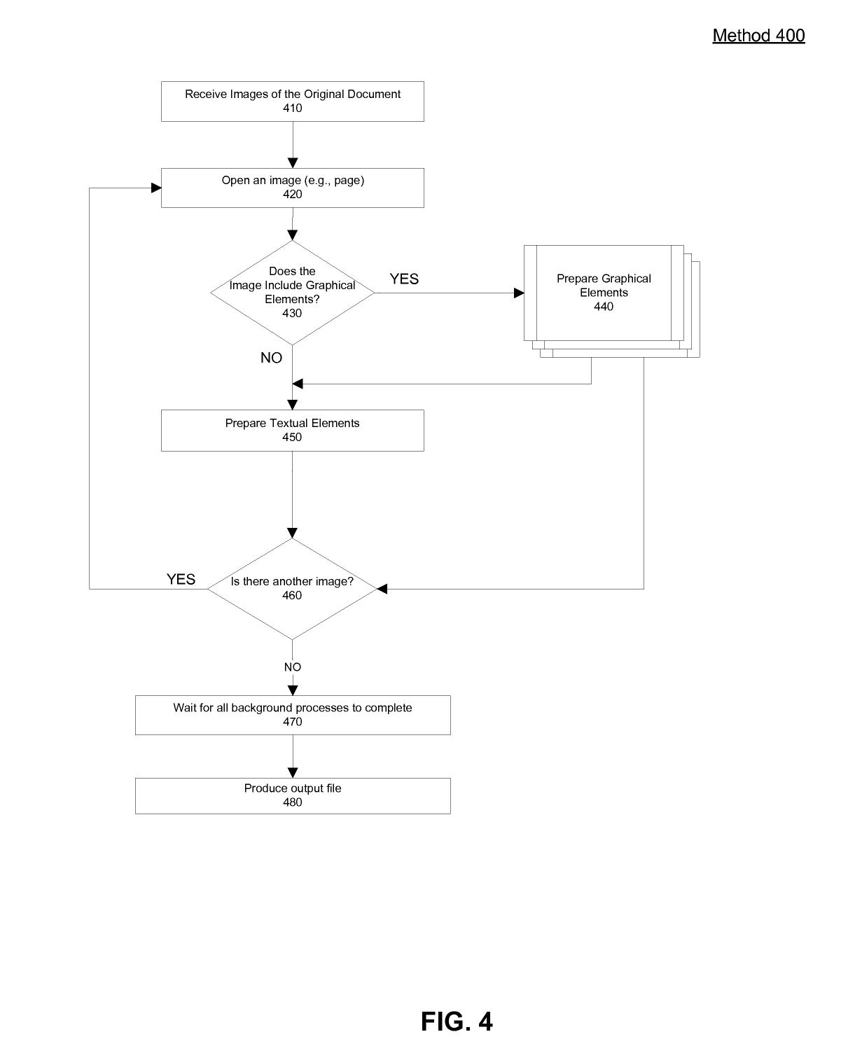

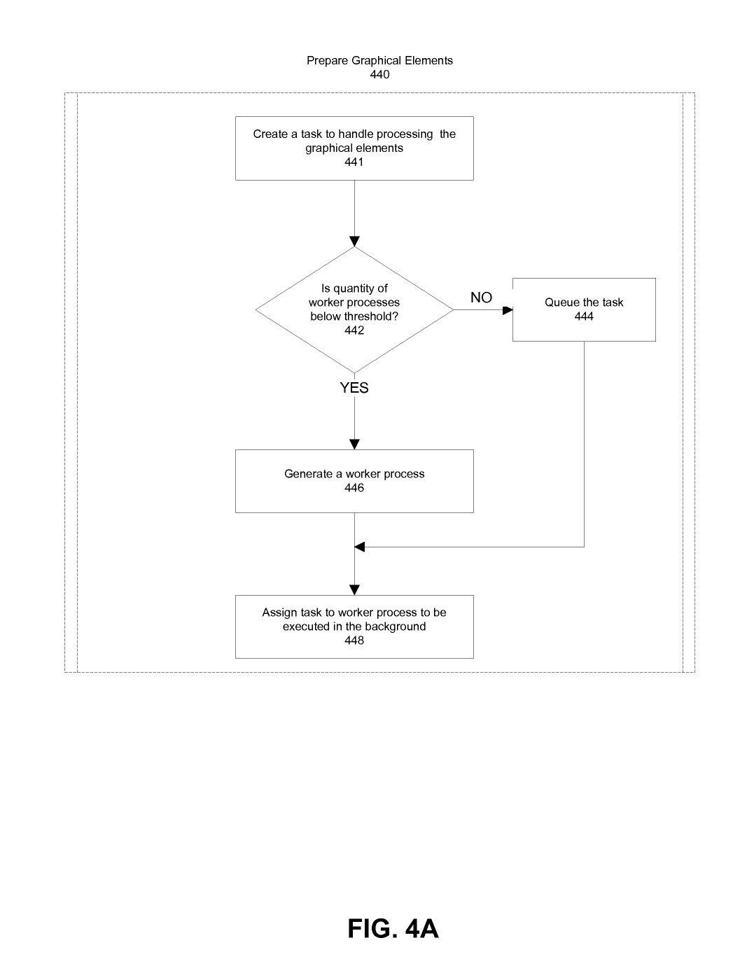

FIG. 4 depicts a flow diagram of one illustrative example of a method 400 for processing electronic documents, in accordance with one or more aspects of the present disclosure. Method 400 and/or each of its individual functions, routines, subroutines, or operations may be performed by one or more processors of the computer device (e.g., computing device 100 of FIG. 1) executing the method. In certain implementations, method 400 may be performed by two or more processing threads, each thread executing one or more individual functions, routines, subroutines, or operations of the method. In an illustrative example, the worker processes or processing threads implementing method 400 may be synchronized (e.g., using semaphores, critical sections, and/or other thread synchronization mechanisms).

At block 410, the computing device performing the method may receive images of original document 310. Original document 310 may be stored in a temporary internal data structure that represents the document, received from another process handling image recognition (e.g., OCR).

At block 420, the computing device may open an image (e.g., page) and at block 430, the computing device may determine whether the image includes at least one graphical element. The computing device may distinguish between the types of elements within an image because it may include a main process 302 and worker process 304A-B that may be dedicated to different elements and utilize different processing technologies. In one example, main process 302 may process textual element 324A within document 310 without processing any graphical elements, and worker processes 304A may process graphical element 322 without processing any textual elements. In another example, the document may include a page (e.g., 320C) with multiple graphical elements. A first graphical element may be a color photograph and the second graphical element may be a black-and-white line art. The worker process may use a first procession algorithm (e.g., lossy compression algorithm) for the first graphical element and a different procession algorithm (e.g., lossless compression algorithm) for the second graphical element.

If the image includes a graphical element the computing device may proceed to block 440 to prepare (process) the graphical elements and then to block 450, otherwise the computing device may branch directly to block 450. In an illustrative example, determining the presence of graphic elements may be performed by accessing reference information. Block 440 and the preparation (processing) of graphical elements is described in more detail below with reference to FIG. 4A.

At block 450, the computing device may prepare (process) the textual elements in the image. In one example, main process 302 may process textual elements of every page of document 310 and each page that includes a graphic may be processed by a separate dedicated worker process, such that a first worker process 304A may process the graphics on a first page and a second worker process 304B may process the graphics on a second page. In another example, main process 302 may only process text on pages without graphics and worker processes 304A-B may process the text, in addition to the graphics, for any pages that have at least one graphical element (e.g., images 320A and 320C).

At block 460, the computing device may test whether the document includes another image, if so it will branch to block 420 and continuously iterate through each image based on the process discussed above. If not, then this is the last page and the computing device may branch to block 470 and wait until all worker processes have completed.

At block 480, the computing device may produce an output file. The output file may be a multi-part document that may be in a hybrid file format. A hybrid file format may be a file, in which different parts of the file are compressed using different compression algorithms. In one example, the output file may be in a hybrid file format such as PDF (PDF/A, PDF/E, PDF/UA, PDF/VT, PDF/X), PPT (PPTX), and/or DOC (DOCX). In one example, the computing device performing the method may assemble multiple images into an output file that is a flattened fixed-layout document file.

Responsive to completing the operations described herein above, the method may terminate.

FIG. 4A depicts a flow diagram that expands the graphical element preparation seen at block 440 of FIG. 4. At block 441, the computing device may create a task for processing an image's graphical elements in a separate or dedicated process (e.g., background process). At block 442, the computing device may determine if the quantity of worker processes is below the threshold quantity of worker processes. If the quantity is below a threshold, the computing device may generate a worker process as shown in block 446. Otherwise, the computing device may queue the task as shown in block 444. At block 448, the computing device may assign the task to the newly created worker process. This worker process may then process the task in the background.

In certain implementations, the functionality may also analyze the layout of the original document to derive the logical structure of the document. The functionality may then apply the logical structure to the extracted textual information to produce an editable electronic file corresponding to the original paper document. The logical structure of a document may comprise a plurality of form elements including images, tables, pages, headings, chapters, sections, separators, paragraphs, sub-headings, tables of content, footnotes, references, bibliographies, abstracts, figures, etc.

FIG. 5 illustrates a more detailed diagram of an example computing device 500 within which a set of instructions, for causing the computing device to perform any one or more of the methods discussed herein, may be executed. The computing device 500 may include the same components as computing device 100 of FIG. 1, as well as some additional or different components, some of which may be optional and not necessary to provide aspects of the present disclosure. The computing device may be connected to other computing device in a LAN, an intranet, an extranet, or the Internet. The computing device may operate in the capacity of a server or a client computing device in client-server network environment, or as a peer computing device in a peer-to-peer (or distributed) network environment. The computing device may be a provided by a personal computer (PC), a tablet PC, a set-top box (STB), a Personal Digital Assistant (PDA), a cellular telephone, or any computing device capable of executing a set of instructions (sequential or otherwise) that specify operations to be performed by that computing device. Further, while only a single computing device is illustrated, the term “computing device” shall also be taken to include any collection of computing devices that individually or jointly execute a set (or multiple sets) of instructions to perform any one or more of the methodologies discussed herein.

Exemplary computing device 500 includes a processor 502, a main memory 504 (e.g., read-only memory (ROM) or dynamic random access memory (DRAM)), and a data storage device 518, which communicate with each other via a bus 530.

Processor 502 may be represented by one or more general-purpose processing devices such as a microprocessor, central processing unit, or the like. More particularly, processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute instructions 522 for performing the operations and functions discussed herein.

Computing device 500 may further include static memory 506, a network interface device 508, a video display unit 510, a character input device 512 (e.g., a keyboard), a cursor control device 514 and signal generation device 516.

Data storage device 518 may include a computer-readable storage medium 528 on which is stored one or more sets of instructions 522 embodying any one or more of the methodologies or functions described herein. Instructions 522 may also reside, completely or at least partially, within main memory 504 and/or within processor 502 during execution thereof by computing device 500. Main memory 504 and processor 502 may also constitute computer-readable storage media. Instructions 522 may further be transmitted or received over network 520 via network interface device 508.

In certain implementations, instructions 522 may include instructions of method 300 and/or 400 for processing document images, and may be performed by module 190 of FIG. 1. While computer-readable storage medium 528 is shown in the example of FIG. 5 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing device, or similar electronic computing device, that manipulates and transforms data represented as physical (e.g., electronic) quantities within the computing device's registers and memories into other data similarly represented as physical quantities within the computing device memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
assigning a plurality of image processing tasks to a plurality of worker processes;
defining input parameters for each task of the plurality of tasks, the input parameters comprising a part of an original document and a structure definition of the part, the structure definition including a reference to an element requiring time-consuming processing comprised by the part of the original document; and
outputting, into a file representing the original document, a plurality of images produced by the worker processes based on the elements requiring time-consuming processing defined by the input parameters.

2. The method of claim 1, wherein the elements requiring time-consuming processing are graphical elements.

3. The method of claim 1, wherein the assigning comprises one of: spawning a new worker process or assigning a task to an existing worker process.

4. The method of claim 1, wherein the part of the original document represents a page of a multi-page document.

5. The method of claim 2, wherein a worker process of the plurality of worker processes is configured to select a compression algorithm based on a type of the graphical element.

6. The method of claim 2, wherein each worker process compresses the graphical element to produce a corresponding image, wherein the corresponding image also includes a change to at least one of, image format, resolution, chromaticity, quality or noise.

7. The method of claim 1, wherein each worker process further outputs an image of the part of the original document to be included into the file, the file being compliant to a certain format.

8. The method of claim 1, further comprising queuing a new task responsive to determining that a quantity of tasks exceeds a quantity of processing units.

9. The method of claim 1, wherein the reference to the element requiring time-consuming processing comprises coordinates of the element requiring time-consuming processing within the original document.

10. A system comprising:
a memory;
a processor, coupled to the memory, the processor configured to:
assign a plurality of image processing tasks to a plurality of worker processes;
define input parameters for each task of the plurality of tasks, the input parameters comprising a part of an original document and a structure definition of the part, the structure definition including a reference to an element requiring time-consuming processing comprised by the part of the original document; and
output, into a file representing the original document, a plurality of images produced by the worker processes based on the elements requiring time-consuming processing defined by the input parameters.

11. The system of claim 10, wherein the elements requiring time-consuming processing are graphical elements.

12. The system of claim 10, wherein the assigning comprises one of: spawning a new worker process or assigning a task to an existing worker process.

13. The system of claim 10, wherein the part of the original document represents a page of a multi-page document.

14. The system of claim 11, wherein a worker process of the plurality of worker processes is configured to select a compression algorithm based on a type of the graphical element.

15. The system of claim 11, wherein each worker process compresses the graphical element to produce a corresponding image, wherein the corresponding image also includes a change to at least one of, image format, resolution, chromaticity, quality or noise reduction.

16. The system of claim 10, wherein each worker process further outputs an image of the part of the original document to be included into the file, the file being compliant to a certain format.

17. The system of claim 9, further comprising queuing a new task responsive to determining that a quantity of tasks exceeds a quantity of processing units.

18. The system of claim 9, wherein the reference to the element requiring time-consuming processing comprises coordinates of the element requiring time-consuming processing within the original document.

19. A computer-readable non-transitory storage medium comprising executable instructions that, when executed by a computing device, cause the computing device to perform operations comprising:
assigning a plurality of image processing tasks to a plurality of worker processes;
defining input parameters for each task of the plurality of tasks, the input parameters comprising a part of an original document and a structure definition of the part, the structure definition including a reference to an element requiring time-consuming processing comprised by the part of the original document; and
outputting, into a file representing the original document, a plurality of images produced by the worker processes based on the elements requiring time-consuming processing defined by the input parameters.

20. The storage medium of claim 19, wherein the elements requiring time-consuming processing are graphical elements.

21. The computer-readable non-transitory storage medium of claim 19, wherein the assigning comprises one of: spawning a new worker process or assigning a task to an existing worker process.

22. The computer-readable non-transitory storage medium of claim 19, wherein the part of the original document represents a page of a multi-page document.

23. The computer-readable non-transitory storage medium of claim 20, wherein a worker process of the plurality of worker processes is configured to select a compression algorithm based on a type of the graphical element.
